(19) United States
(12) Patent Application Publication
(10) Pub. No.: US 2014/0332358 A1
(43) Pub. Date: Nov. 13, 2014

(54) OPERATION KEY AND SWITCHING UNIT

(71) Applicant: ORMON CORPORATION, Kyoto-shi (JP)

(72) Inventors: Masayuki Shinohara, Nagaokakyo-shi (JP); Takako Ishikawa, Kobe-shi (JP); Ryoji Okazaki, Ichinomiya-shi (JP)

(73) Assignee: OMRON CORPORATION, Kyoto-shi, KT (JP)

(21) Appl. No.: 14/240,555

(22) PCT Filed: Sep. 27, 2012
(86) PCT No.: PCT/JP2012/074994

§ 371 Date: Feb. 24, 2014

(30) Foreign Application Priority Data
Sep. 30, 2011 (JP) 201121853

(51) Int. Cl. H01H 13/02

(52) U.S. Cl. CPC H01H 13/023; H01H 2233/00
USPC 200/314

(57) ABSTRACT

An operation key including an image transmissive part configured to transmit an image of display information located behind the image transmissive part, where an inclined surface is formed in at least a part of a rear surface of the image transmissive part, and the inclined surface is inclined onto a front surface side of the image transmissive part toward a far side from a side near an operator.

### CROSS-REFERENCE TO RELATED APPLICATION

This application is the United States National Phase of International Patent Application Number PCT/JP2012/074994 filed on 27 Sep. 2012 which claims priority to Japanese Patent Application No. 2011-218153 filed on 30 Sep. 2011, all of which said applications are herein incorporated by reference in their entirety.

### TECHNICAL FIELD

The present invention relates to an operation key and a switch unit, specifically to an operation key through which display information behind the operation key can be seen, and a switch unit including the operation key.

### BACKGROUND ART

A switch unit is known that can display information such as a character or a pattern on a top surface of an operation key. For example, see Japanese Unexamined Patent Publication No. 2003-77357, hereinafter referred to as Patent Document. FIGS. 1(A) and 1(B) are a sectional view and an exploded perspective view of a switch unit (switch with display) described in Patent Document 1.

In a switch unit 11 in FIG. 1, on and off operations of a switch 12 can be performed by pressing an operation key 13, and a liquid crystal display 14 and a convex lens 15 are incorporated in the operation key 13. The operation key 13 is constructed by a top cover 13a constituting an operation surface and frame bodies 13b and 13c. The liquid crystal display 14 is incorporated in the lower frame body 13c, and constructed by a liquid crystal display panel 16, a diffuser 17 disposed on a rear surface of the liquid crystal display panel 16, and an LED 18 disposed in an outer peripheral portion of the diffuser 17. The convex lens 15 is accommodated in the upper frame body 13b, and disposed between the liquid crystal display panel 16 and the top cover 13a of the operation key 13.

In the switch unit 11, the display information, such as the character and the pattern, which is expressed on the liquid crystal display 14, can be recognized through the operation key 13, and the display information image reflected on the operation key 13 can be changed by changing the display information of the liquid crystal display 14.

However, in the switch unit 11, because of a long distance from a surface of the operation key 13 to the display information image, the image appears to be retreated when viewed from operation key 13. Although the image should be displayed on the surface of the operation key from the standpoint of the purpose of the switch unit, the image appears to be retreated from the surface of the operation key in the conventional switch unit.

The switch unit 11 includes the convex lens 15. The convex lens 15 is used to magnify the image, and hardly serves to raise the display information image to the surface of the operation key 13.

In the switch unit 11 disclosed in Patent Document 1, a low-profile switch unit 11 is hardly obtained because the distance from the liquid crystal display 14 to the surface of the operation key 13 is lengthened to enlarge the operation key 13.

In the switch unit 11 disclosed in Patent Document 1, in the case that the plural switch units 11 are arrayed, the liquid crystal displays 14 are required by the number of switch units 11, and cost increases.

### BRIEF SUMMARY

The present invention has been devised to solve the above technical problem, and provides an operation key that can give an operator an optical illusion that the display information image is recognized near the surface of the operation key or at a shallow position from the surface of the operation key and a switch unit in which the operation key is used.

The invention provides an operation key including an image transmissive part configured to transmit an image of display information located behind the image transmissive part, where an inclined surface is formed in at least a part of a rear surface of the image transmissive part, and the inclined surface is inclined onto a front surface side of the image transmissive part toward a far side from a side near an operator.

The invention further provides an operation key including an image transmissive part configured to transmit an image located behind the image transmissive part, where at least one of outer peripheral surfaces of the image transmissive part is inclined inward from an end on a rear surface side of the image transmissive part toward an end on a front surface side of the image transmissive part.

### BRIEF DESCRIPTION OF THE DRAWINGS

FIG. 1(A) is a sectional view of a switch unit (switch with display) described in Patent Document 1, and FIG. 1(B) is an exploded perspective view of a part of the switch unit.

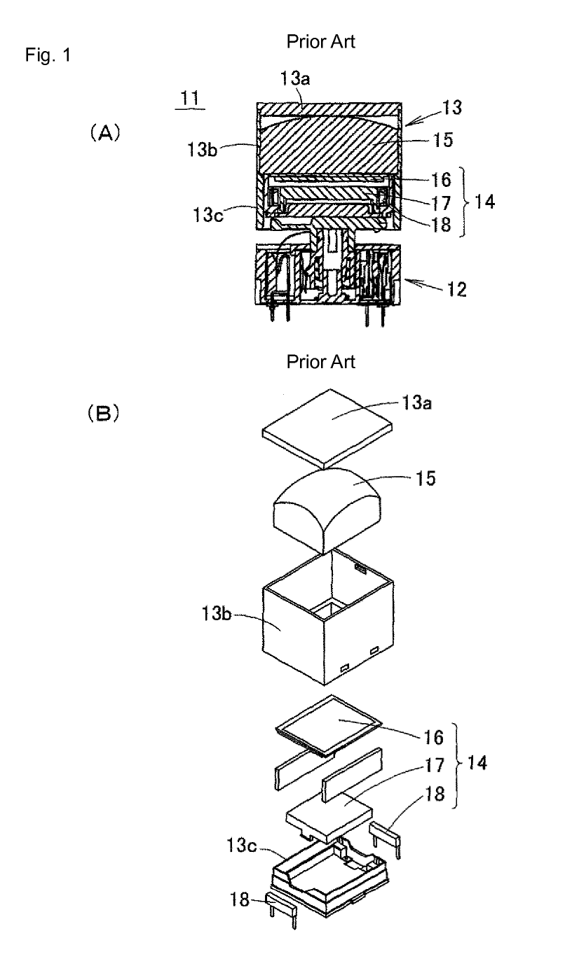

FIGS. 2(A) and 2(B) are sectional views of a switch unit according to a first embodiment of the present invention, FIG. 2(A) is a sectional view taken on a line X1-X1 of FIG. 3, and FIG. 2(B) is a sectional view taken on a line Y1-Y1 of FIG. 3.

FIG. 3 is a plan view of the switch unit according to the first embodiment of the present invention.

FIGS. 4(A) and 4(B) are schematic diagrams illustrating an appearance of an image in the case that an operation key of a comparative example is used.

FIGS. 5(A) and 5(B) are schematic diagrams illustrating the appearance of the image in the case that an operation key of another comparative example is used.

FIGS. 6(A) and 6(B) are schematic diagrams illustrating the appearance of the image in the case that an operation key of the first embodiment of the present invention is used.

FIG. 7(A) is a sectional view illustrating an operation key according to a modification of the first embodiment, and FIG. 7(B) is a sectional view illustrating an operation key according to another modification of the first embodiment.

FIGS. 8(A) and 8(B) are sectional views illustrating an operation key according to still another modification of the first embodiment.

FIG. 9(A) is a plan view illustrating a switch unit according to a second embodiment of the present invention, and FIG. 9(B) is a sectional view taken on a line X2-X2 of FIG. 9(A).

FIGS. 10(A) and 10(B) are schematic diagrams illustrating the appearance of the image in the case that an operation key of the second embodiment of the present invention is used.

FIGS. 11(A) and 11(B) are sectional views illustrating an operation key according to a modification of the second embodiment, and FIGS. 11(C) and 11(D) are sectional views illustrating an operation key according to another modification of the second embodiment.

FIG. 12(A) illustrates the appearance of the image, particularly the appearance of the image of a sidewall on a side far away from an operator in the case that the operation key of a modification of the second embodiment is used, and FIG. 12(B) illustrates the appearance of the image, particularly the appearance of the image of the sidewall on the side far away from the operator in the case that the operation key of the first embodiment is used.

FIG. 13(A) is a plan view of a switch unit according to a third embodiment of the present invention, and FIG. 13(B) is a sectional view taken on a line X3-X3 of FIG. 13(A).

FIGS. 14(A) and 14(B) are schematic diagrams illustrating the appearance of the image in the case that an operation key of the third embodiment is used.

FIG. 15(A) illustrates the appearance of the image, particularly the appearance of the image of the sidewall of a side surface in the case that the operation key in which the sidewalls of both the side surfaces are perpendicular surfaces is used, and FIG. 15(B) illustrates the appearance of the image, particularly the appearance of the image of a sidewall of the side surface in the case that the operation key of the third embodiment is used.

FIG. 16 is a ray diagram illustrating a behavior of light incident to the operation key in which the sidewall is the perpendicular surface.

FIG. 17 is a ray diagram illustrating the behavior of the light incident to the operation key of the third embodiment.

FIG. 18 is a sectional view illustrating an operation key according to a modification of the third embodiment.

FIG. 19(A) is a plan view of a switch unit according to a fourth embodiment of the present invention, and FIG. 19(B) is a sectional view taken on a line X4-X4 of FIG. 19(A).

FIG. 20(A) is a sectional view taken on a line Y4-Y4 of FIG. 19(A), and FIG. 20(B) is another sectional view taken on the line Y4-Y4 of FIG. 19(A).

FIGS. 21(A) and 21(B) are sectional views of a switch unit according to a modification of the fourth embodiment.

FIGS. 22(A) and 22(B) are sectional views of an operation key according to another modification of the fourth embodiment, and FIGS. 22(C) and 22(D) are sectional views of an operation key according to still another modification of the fourth embodiment.

FIGS. 23(A), 23(B), and 23(C) are sectional views of an operation key according to yet another modification of the fourth embodiment.

FIG. 24(A) is a sectional view of a switch unit according to a fifth embodiment of the present invention, and FIG. 24(B) is an exploded sectional view of an operation key of the switch unit.

FIG. 25 is an exploded perspective view of the operation key of the fifth embodiment.

FIGS. 26(A) to 26(H) are sectional views illustrating various shapes of surfaces of the operation keys.

FIGS. 27(A) to 27(H) are sectional views illustrating various shapes of surfaces of the operation keys.

FIG. 28(A) is a plan view of a switch unit according to a sixth embodiment of the present invention, and FIG. 28(B) is a schematic sectional view of the switch unit of the sixth embodiment.

FIG. 29 is an exploded perspective view of the switch unit of the sixth embodiment.

### DETAILED DESCRIPTION

Hereinafter, preferred embodiments of the present invention will be described below with reference to accompanying drawings. However, the present invention is not limited to the following embodiments, but various design changes can be made without departing from the scope of the present invention.

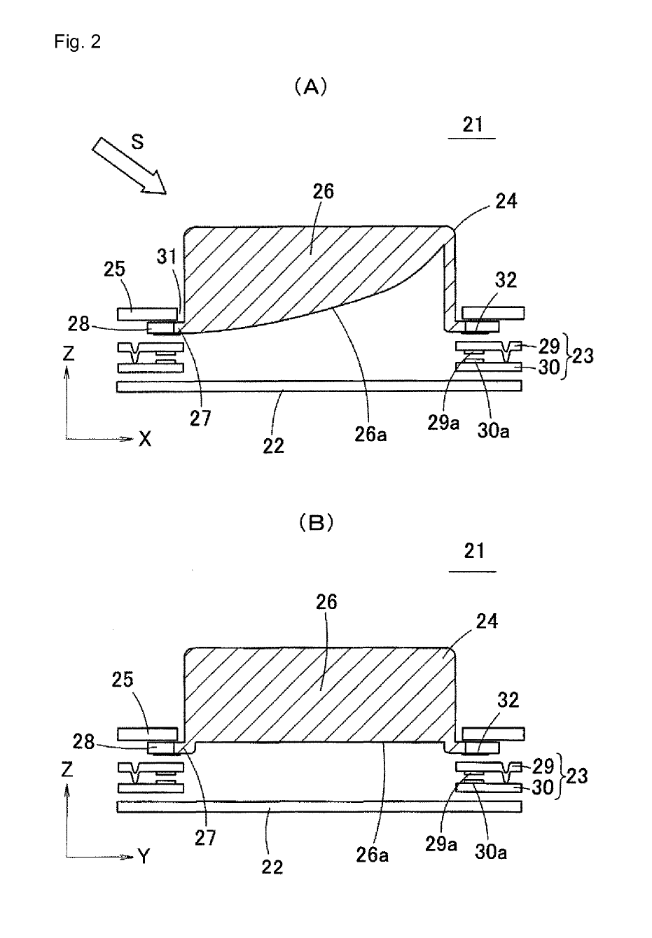

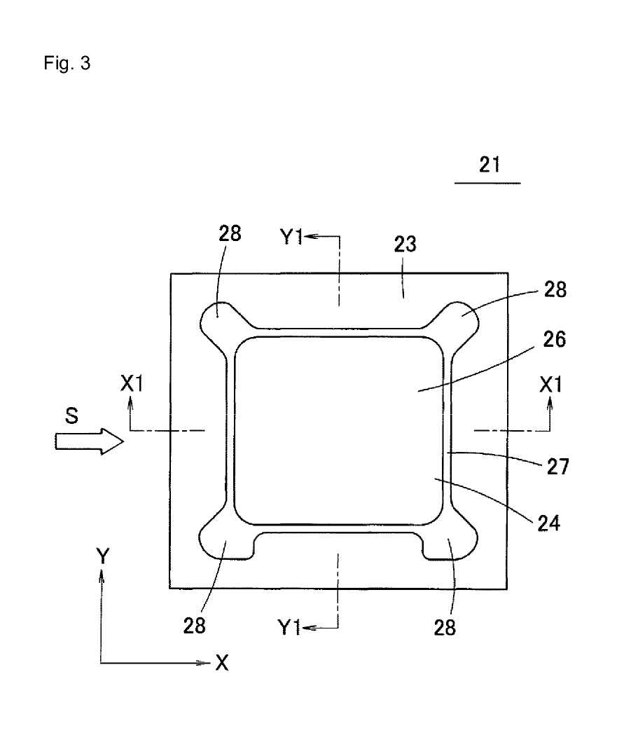

Structures of a switch unit 21 and an operation key 24 according to a first embodiment of the present invention will be described below with reference to FIGS. 2 and 3. FIG. 2(A) is a sectional view of the switch unit 21, and is the sectional view taken on a line X1-X1 of FIG. 3. FIG. 2(B) is a sectional view of the switch unit 21, and is the sectional view taken on a line Y1-Y1 of FIG. 3. FIG. 3 is a plan view of the switch unit 21. However, a frame 25 is omitted in FIG. 3. The following directions of the right, left, up and down are not limited to an attitude in installing the switch unit, but indicate only the directions on the drawings.

As illustrated in FIGS. 2(A) and 2(B), in the switch unit 21, a sheet switch 23 is stacked on an image display part 22, an operation key 24 is placed on the sheet switch 23, and a frame 25 is stacked on the operation key 24. The image display part 22 displays display information such as a character or a pattern on a region opposed to the operation key 24.

Desirably electronic display devices such as a Liquid Crystal Display (LCD) or an organic EL are used as the image display part 22. Alternatively, a simple printed material may be used as the image display part 22. An image can electronically be changed in the case that the image display part 22 is the electronic display device. The image display part 22 separates from the operation key 24, and only disposed behind the operation key 24. Therefore, in the case that the image display part 22 is the printed material, the image can also be changed by replacing the printed material.

As illustrated in FIG. 3, in the operation key 24, a flange 27 extends in a lower portion of an outer peripheral surface of an image transmissive part 26 having a substantially quadrangular prism shape, and leg pieces 28 project toward diagonal directions from four corners of the flange 27. The operation key 24 is formed by injection molding using transparent or translucent resins such as polycarbonate and polymethylmethacrylate (PMMA). Desirably the operation key 24 is molded using the transparent resin. However, the operation key 24 may be molded using the translucent resin having a high degree of transparency or the slightly-colored translucent resin.

A keytop (sometimes referred to as a front surface or a surface) of the image transmissive part 26 has a planar surface or a spherical surface swelling slightly forward (upward direction in FIGS. 2(A) and 2(B)). In FIGS. 2(A) and 3, an arrow S expresses a visual line direction in which a person (operator) who operates the operation key 24 sees the operation key 24. A rear surface 26a (sometimes referred to as a lower surface) of the image transmissive part 26 becomes a curved inclined surface, and is inclined onto the front surface side of the image transmissive part 26 toward the far side from the side near the operator as illustrated in FIG. 2(A). In the first embodiment, the rear surface 26a (inclined surface) of the image transmissive part 26 becomes a curved surface having a single arc or complex arc cylindrical shape in section, the rear surface 26a is curved so as to swell toward the rear surface side as illustrated in FIG. 2(A) in a ZX-plane, and the rear surface 26a becomes linear as illustrated in FIG. 2(B) in a YZ-plane. The rear surface 26a of the image transmissive part 26 in FIG. 2(A) has the complex arc cylindrical shape in section such that the curvature radius decreases gradually toward the far side from the side near the operator. Alternatively, the curvature radius may divisionally be changed in the complex arc cylindrical shape in section. For example, the rear surface 26a is divided into a region near the operator and a region far away from the operator, has the constant and relatively large curvature in the region near the operator, and has the constant and relatively small curvature in the region far away from the operator. The rear surface 26a of the image transmissive part 26 may become the arc shape in section (single arc cylindrical shape in section) in which a curvature radius is kept constant. In the description, a Z-axis is set to the direction perpendicular to the front surface of the operation key 24, an X-axis is set to the direction orthogonal to the Z-axis in a plane including the visual line direction of the operator and the Z-axis, and a Y-axis is set to the direction orthogonal to the Z-axis and the X-axis.

The frame 25 is a molding product made of hard plastic, and includes an opening 31 in which the image transmissive part 26 is inserted. In the operation key 24, the image transmissive part 26 is slidably inserted from below into the opening 31 of the frame 25, and an edge of the opening 31 is located on the flange 27, whereby the image transmissive part 26 is regulated so as not to come out upward.

In the sheet switch 23, an upper board 29 is stacked on a lower board 30. Immediately below the leg piece 28 of the operation key 24, contacts 29a and 30a are provided on surfaces opposed to each other in the upper board 29 and the lower board 30. Wirings (not illustrated) in conduction with the contacts 29a and 30a are formed in the upper board 29 and the lower board 30. A projection 32 is provided on the lower surface of the leg piece 28 such that the sheet switch 23 is pressed to bring the contacts 29a and 30a into contact with each other.

The upper board 29 is made of a soft and elastic material such as a silicone rubber, and an irregular rib is formed in the upper board 29. The lower board 30 is constructed by a printed wiring board. The contact 29a of the upper board 29 is floated from the contact 30a by abutting the rib of the upper board 29 on the lower board 30, and the contacts 29a and 30a are insulated from each other in a usual state. The operation key 24 is placed on the upper board 29 while each leg piece 28 is located immediately above the contacts 29a and 30a.

In the switch unit 21, the image transmissive part 26 is made of a transparent or translucent material, so that the operator can recognize the display information (for example, display of a type or function of the switch) of the image display part 22 through the image transmissive part 26. When the operator presses the keytop of the operation key 24, the leg piece 28 presses the contact 29a, and the contact 29a comes into contact with the contact 30a to turn on the sheet switch 23, thereby detecting that the operation key 24 is pressed. When the operator releases the operation key 24, the contact 29a separates from the contact 30a by an elastic returning force of the upper board 29 to turn off the sheet switch 23. At the same time, the operation key 24 is pushed up by the elastic returning force of the upper board 29 to return to an original position.

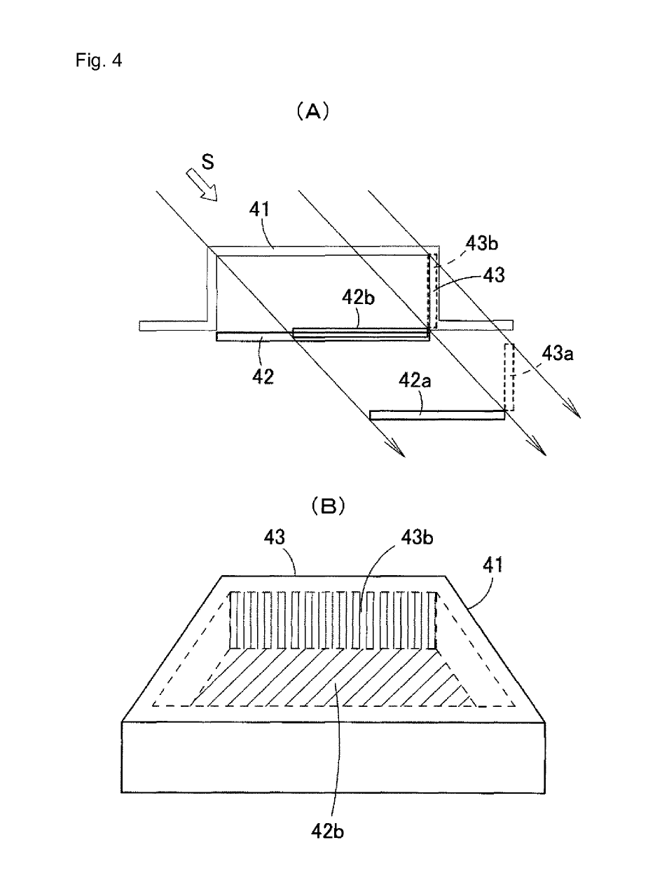

In the switch unit 21, the optical illusion (visual illusion) is given to the operator that the display information image displayed on the image display part 22 is floating, and to the operator it appears that the image exists on the surface (keytop) of the operation key 24 or in a vicinity of the surface. The reason will be described below with reference to FIGS. 4 to 7. An image forming position is excluded in the following description.

FIGS. 4(A) and 4(B) illustrate an operation key 41 of a comparative example, and the operation key 41 has a box shape in which a rear surface includes a recess. In the case that the display information 42 is seen through the operation key 41, because display information 42 is partially blocked by a sidewall (outer peripheral surface) on an operator side as illustrated in FIG. 4(A), an image 42a seen through the operation key 41 becomes part of the display information 42. The image of a sidewall 43 on the side far away from the operator becomes an image 43a expressed by a broken line. Therefore, the image seen through the operation key 41 is images 42a and 43a in FIG. 4 (the image forming position is excluded).

In the case that a person recognizes the position of an object, the person reasonably makes a determination not only depending on a visual distance sense but also by receiving auxiliary information except the visual distance sense. In the case of FIG. 4(A), because the sidewall 43 exists beneath the top surface of the operation key 41, the image 43a of the sidewall 43 is determined to be located beneath the top surface of the operation key 41 (due to the optical illusion). That is, the image of the sidewall 43 is unconsciously determined to be located at the position of an image 43b in FIG. 4(A). Accordingly, the image of the display information 42 is also determined to be located at the position of an image 42b in FIG. 4(A). As a result, in the case that the operation key 41 is used, the position of the image 42b of the display information 42 is substantially unchanged from the original position of the display information 42 as illustrated in FIG. 4(B), and the image 42b is recognized at the position considerably retreated from the top surface of the operation key 41.

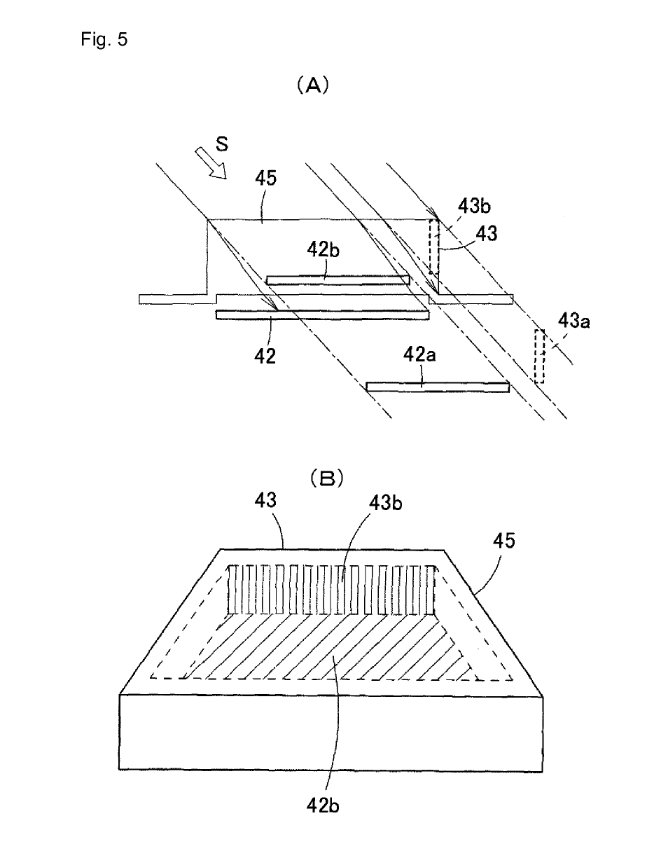

FIGS. 5(A) and 5(B) illustrate an operation key 45 of another comparative example, and the top surface of the image transmissive part 26 is parallel to the lower surface, and the image transmissive part 26 is thick. In the case that the display information 42 is seen through the operation key 45, the image 43a of the sidewall 43 on the side far away from the operator appears to be slightly lower than the sidewall 43 by an influence of refraction of light as illustrated in FIG. 5(A). In the case that the image 43a is determined to be located at the position of the image 43b in FIG. 5(A), it is recognized that the image of the display information 42 exists at the position of the image 42b in FIG. 5(A). Therefore, in the case that the operation key 45 is used, although the position of the image 42b of the display information is slightly floated compared with the case that the operation key 41 in FIG. 4 is used, the floating effect is small.

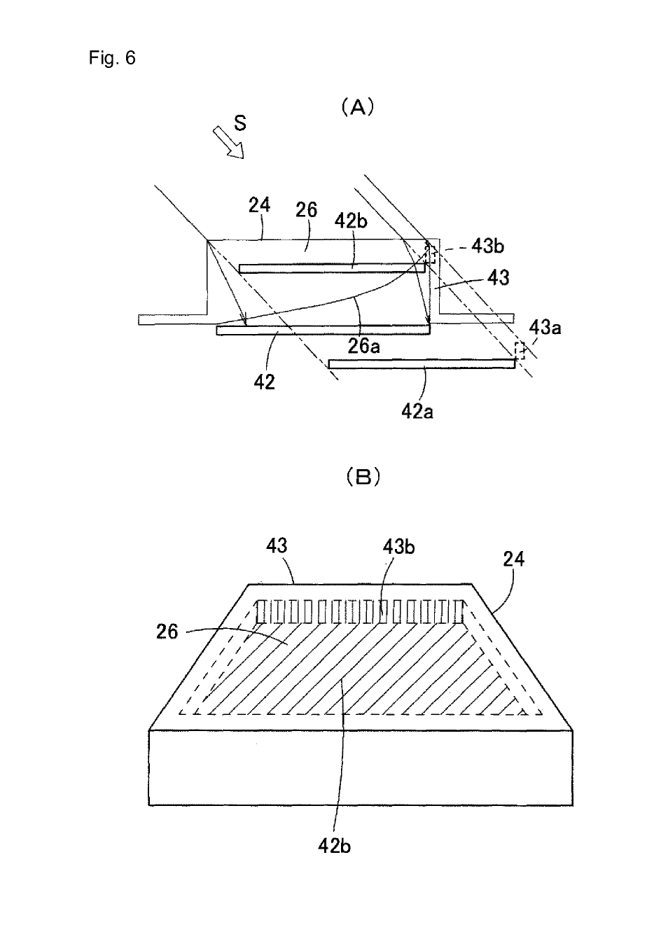

FIGS. 6(A) and 6(B) illustrate the case that the operation key 24 of the first embodiment of the present invention is used. In the case that the display information 42 is seen through the operation key 24 of the first embodiment, the image 43a of the sidewall 43 on the side far away from the operator appears to be considerably lower than the sidewall 43 by lens action of the image transmissive part 26 as illustrated in FIG. 6(A). In the case that the image 43a is determined to be located beneath the top surface of the operation key 24 like the image 43b in FIG. 6(A), it is recognized that the image of the display information 42 exists at the position of the image 42b in FIG. 6(A). Therefore, in the case that the operation key 24 is used, the position of the image 42b comes considerably close to the top surface of the operation key 24 as illustrated in FIG. 6(B). Accordingly, the distance from the top surface of the operation key 24 to the image 42b is shortened to considerably improve the feeling that the image 42b of the display information 42 seen through the operation key 24 is retreated.

In Patent Document 1, the liquid crystal display is incorporated in the operation key in the switch unit disclosed. Therefore, in the case that the plural operation keys are arrayed, the plural liquid crystal displays are required, and the cost increases. On the other hand, in the switch unit 21 of the first embodiment of the present invention, the operation key 24 and the image display part 22 are separately formed. Therefore, even if plural operation units are arrayed, the image display part 22 is commonly used to decrease the number of image display parts 22 as few as possible (see sixth embodiment), and the cost can be reduced. At the same time, in the switch unit 21 of the first embodiment, there is a risk of slightly lengthening the distance between the top surface of the operation key 24 and the image display part 22. However, in the switch unit 21, the image of the image display part 22 can be floated on the surface of the operation key 24, and the switch unit 21 has a good exterior.

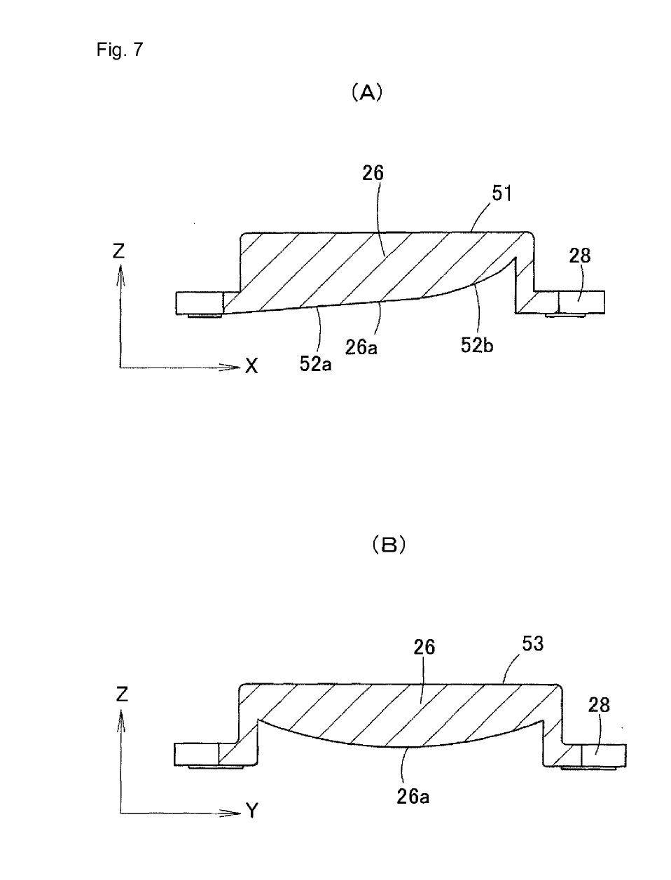

Various modifications of the switch unit of the first embodiment will be described below. FIG. 7(A) is a sectional view of an operation key 51 according to a modification of the first embodiment, and illustrates a section parallel to the ZX-plane. In the operation key 51, a portion near the operator in the rear surface 26a of the image transmissive part 26 is used as a planar inclined surface 52a, and a portion far away from the operator is used as a curved inclined surface 52b.

FIG. 7(B) is a sectional view of an operation key 53 according to another modification of the first embodiment, and illustrates a section parallel to the YZ-plane. In the operation key 53, the rear surface 26a of the image transmissive part 26 becomes a spherically-curved inclined surface. That is, the section parallel to the ZX-plane has the same section in FIG. 2(A), and the section parallel to the YZ-plane has the section in FIG. 7(B).

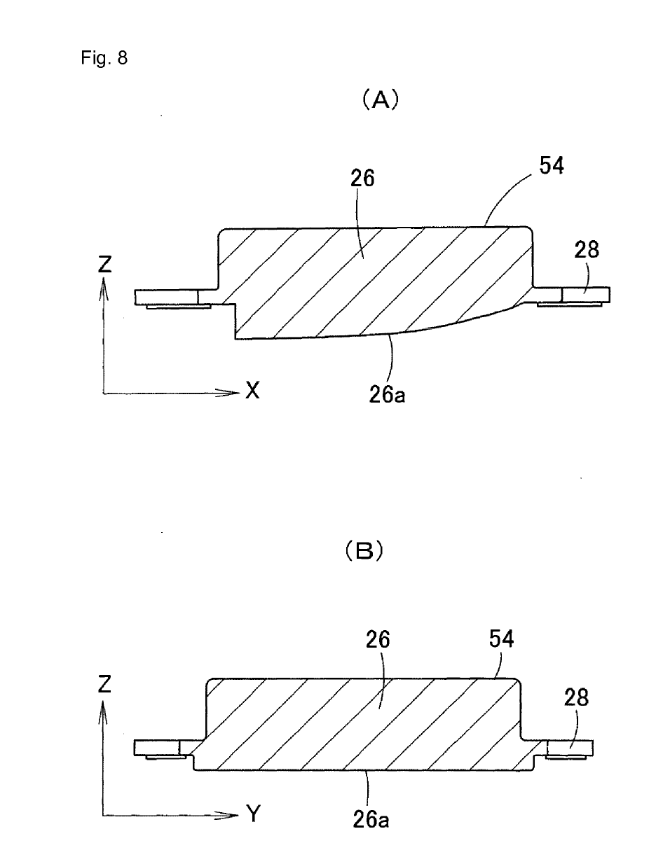

FIG. 8 is a sectional view of an operation key 54 according to still another modification of the first embodiment, FIG. 8(A) illustrates a section parallel to the ZX-plane, and FIG. 8(A) illustrates a section parallel to the YZ-plane. In the operation key 54, the rear surface 26a of the image transmissive part 26 projects downward from the lower surface (rear surface) of the leg piece 28. In the case that the rear surface 26a of the image transmissive part 26 projects downward from the lower surface of the leg piece 28, the effect that floats the image to the vicinity of the surface of the image transmissive part 26 is enhanced compared with the case that the rear surface 26a is retreated upward from the lower surface of the leg piece 28.

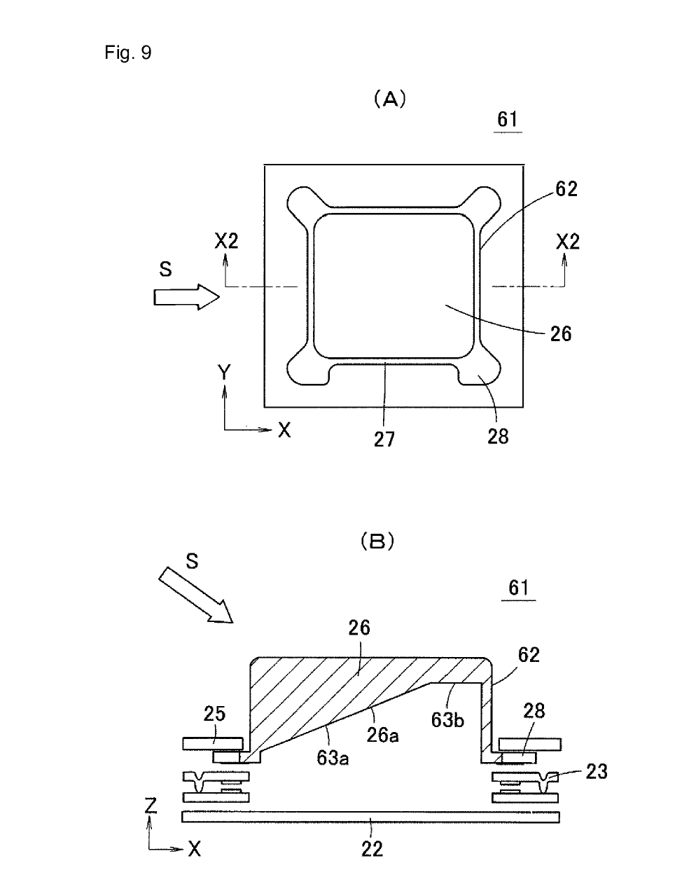

FIG. 9(A) is a plan view (frame 25 is neglected) illustrating a switch unit 61 according to a second embodiment of the present invention, and FIG. 9(B) is a sectional view taken on a line X2-X2 of FIG. 9(A).

In the switch unit 61 of the second embodiment, the rear surface 26a of the image transmissive part 26 provided in the operation key 62 is partially formed by a planar inclined surface 63a. That is, in the rear surface 26a of the image transmissive part 26, the region near the operator is formed by the planar inclined surface 63a, and the inclined surface 63a is inclined onto the side of the top surface of the image transmissive part 26 toward the far side from the side near the operator. In the rear surface 26a of the image transmissive part 26, the region far away from the operator constitutes a horizontal surface 63b.

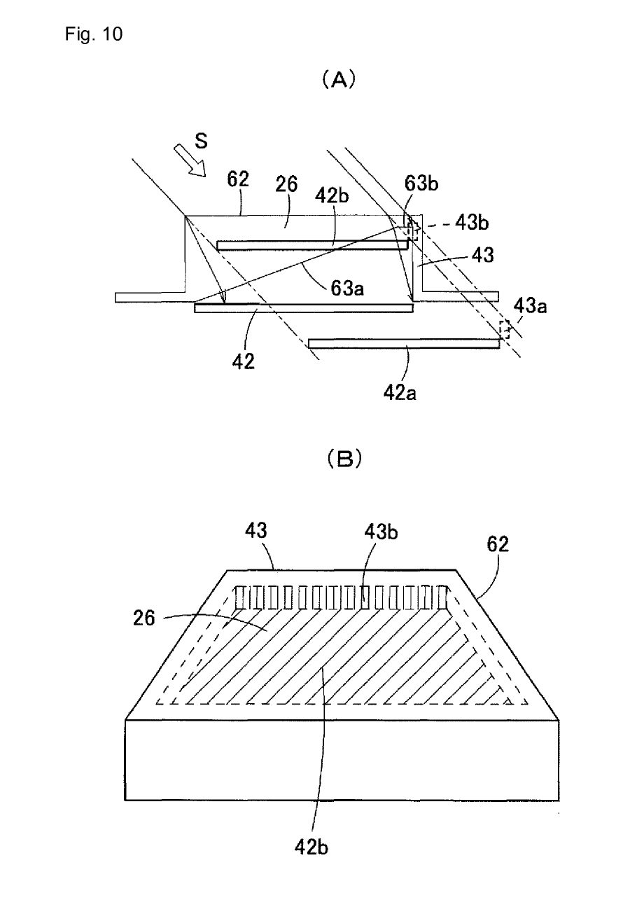

In the switch unit 61, because part of the image transmissive part 26 is formed into a prism shape by the inclined surface 63a, as illustrated in FIGS. 10(A) and 10(B), the image 43b of the sidewall 43 on the side far away from the operator is lowered in the image transmissive part 26 by prism action of the image transmissive part 26, and the image 42b of the display information 42 appears to be floated to the vicinity of the top surface of the operation key 62.

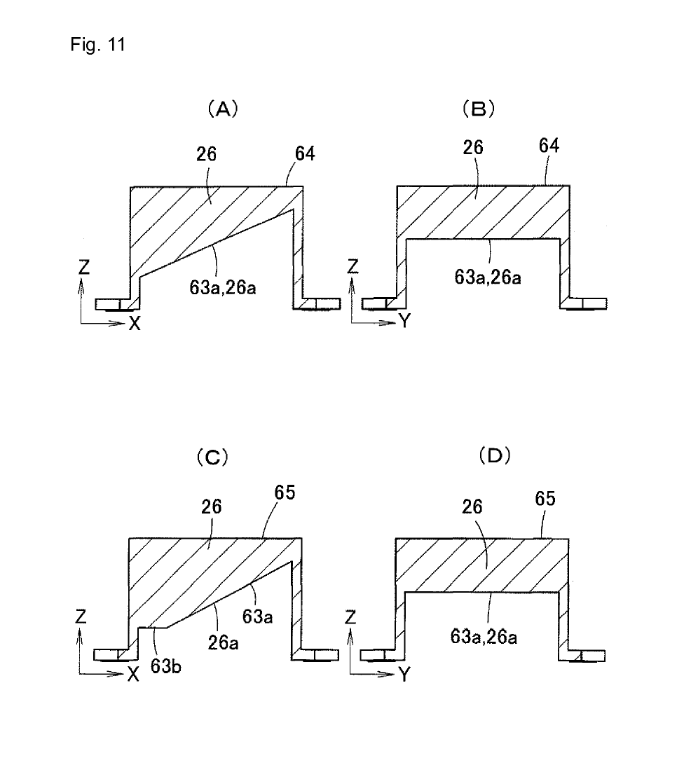

FIGS. 11(A) and 11(B) are sectional views illustrating an operation key 64 according to a modification of the second embodiment, FIG. 11(A) illustrates a section parallel to the ZX-plane, and FIG. 11(B) illustrates a section parallel to the YZ-plane. In the operation key 64, the substantially whole of rear surface 26a of the image transmissive part 26 is formed by the planar inclined surface 63a.

FIGS. 11(C) and 11(D) are sectional views illustrating an operation key 65 according to another modification of the second embodiment, FIG. 11(C) illustrates a section parallel to the ZX-plane, and FIG. 11(D) illustrates a section parallel to the YZ-plane. In the operation key 65, the region far away from the operator in the rear surface 26a of the image transmissive part 26 is formed by the planar inclined surface 63a, and the inclined surface 63a is inclined onto the side of the top surface of the image transmissive part 26 toward the far side from the side near the operator. In the rear surface 26a of the image transmissive part 26, the region near the operator constitutes the planar horizontal surface 63b.

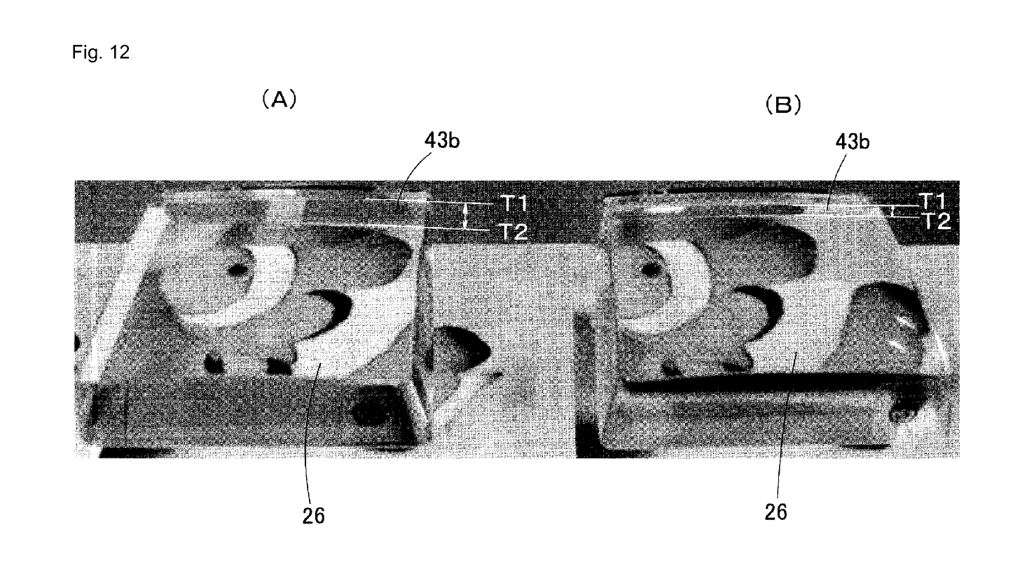

In the case that the operation key 62 of the second embodiment and the operation keys 64 and 65 of the modifications of the second embodiment are used, it can be recognized that the image exists on the top surface of each operation key. However, the effect that floats the image becomes prominent in the case that the rear surface 26a of the image transmissive part 26 is curved like the first embodiment. FIGS. 12(A) and 12(B) illustrate comparison between the case that the operation key 64 of a modification of the second embodiment is used and the case that the operation key 24 of the first embodiment is used. FIG. 12(A) illustrates the state in which the display information is seen using the image transmissive part 26 (a product comparable to the modifications of the second embodiment) that includes the planar inclined surface 63a having an inclination angle of 10° with respect to a horizontal plane. FIG. 12(B) illustrates the state in which the display information 42 is seen from the operator side using the image transmissive part 26 (a product comparable to the first embodiment) including the cylindrical lens shaped-curved rear surface 26a. However, the image transmissive part 26 having the moderately-curved top surface is used in each case. In FIGS. 12(A) and 12(B), the symbol T1 indicates an upper end edge of the sidewall (the image reflected on the sidewall) on the side far away from the operator, the symbol T2 designates a lower end edge of the sidewall. When FIGS. 12(A) and 12(B) are compared to each other, the case (FIG. 12(B)) that the rear surface is formed into the cylindrical lens shape is smaller than the case of (FIG. 12(A)) in the apparent height (distance between T1 and T2) of the sidewall, and the display information image appears to be near the surface of the image transmissive part 26. Therefore, the first embodiment is higher than the second embodiment in the effect that floats the image. However, in the case that the rear surface 26a is curved, there is a risk of slightly deforming the image compared with the case that the rear surface 26a is the planar inclined surface.

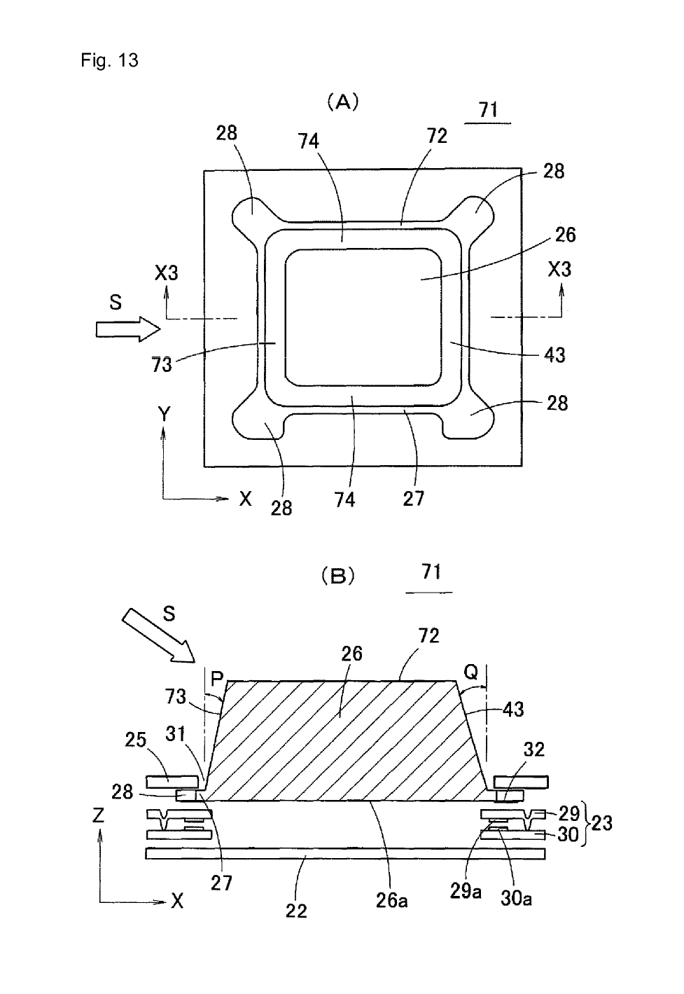

FIG. 13(A) is a plan view (frame 25 is omitted) of a switch unit 71 according to a third embodiment of the present invention, and FIG. 13(B) is a sectional view taken on a line X3-X3 of FIG. 13(A). The section in the direction orthogonal to the section taken on the line X3-X3 of the switch unit 71 is similar to the section taken on the line X3-X3.

The switch unit 71 according to the third embodiment has the same structure as the first embodiment with respect to the component structure except an operation key 72. In the operation key 72, the flange 27 extends in the lower portion of the outer peripheral surface of the image transmissive part 26 having a substantially truncated square pyramid shape, and the leg piece 28 projects toward the diagonal direction from each of the four corners of the flange 27. The operation key 72 is molded using the transparent or translucent resin. Desirably the operation key 72 is desirably molded using the transparent resin. However, the operation key 72 may be molded using the translucent resin having the high degree of transparency or the slightly-colored translucent resin.

The top surface (keytop) of the image transmissive part 26 has a planar surface or a spherical surface swelling slightly forward. The lower surface (rear surface 26a) of the image transmissive part 26 becomes the planar surface parallel to the top surface. The outer peripheral surface (sidewall) of the image transmissive part 26 is inclined inward toward the top surface (end on front surface side) from the lower surface (end on rear surface side) of the image transmissive part 26. As to the measured inclination of each sidewall with respect to the Z-axis, assuming that P is the inclination of the sidewall 73 on the side near the operator, and that Q is the inclination of the sidewall 43 on the side far away from the operator, the inclinations P and Q may be fixed such that P≦Q is satisfied. For example, desirably the inclination P of the sidewall 73 on the side near the operator is set to about 5° and the inclination Q of the sidewall 43 on the side far away from the operator is set to a range of about 15° to 20°. The inclinations of other sidewalls, namely, the sidewalls 74 of both the side surface may be equalized to the inclination of the sidewall 43 on the side far away from the operator. The reason the inclination of the sidewall 73 on the side near the operator is set so as not to be larger than the inclinations of the sidewalls 43 and 74 is that the light leaking toward the direction of the operator from the sidewall 73 increases when the sidewall 73 on the side near the operator is excessively inclined.

In the case that the sidewall of the operation key 72 is inclined like the switch unit 71, it is recognized that the image exists near the top surface of the image transmissive part 26 due to the optical illusion when the display information 42 is displayed on the image display part 22. The reason will be described below.

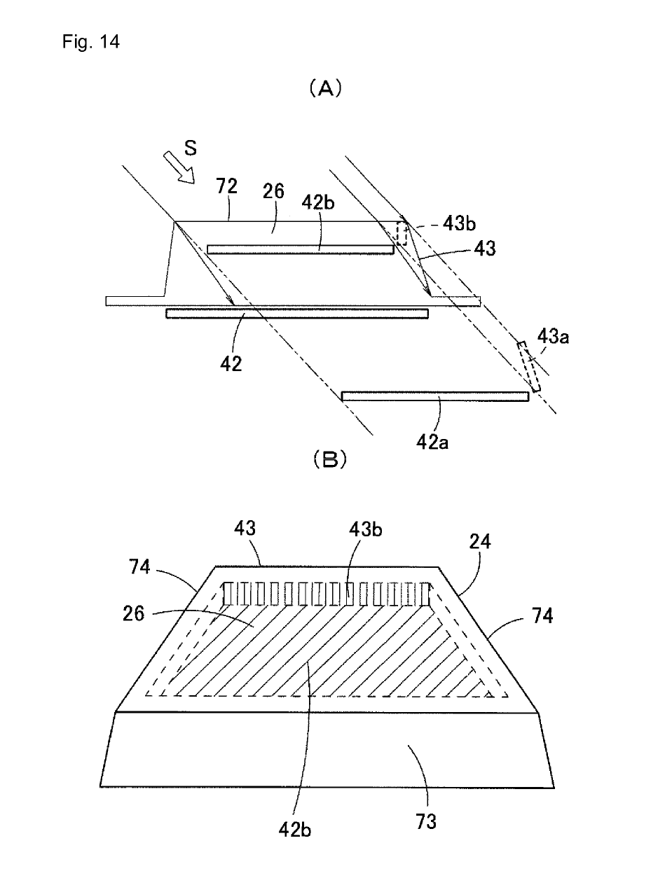

When the sidewall 43 located on the side far away from the operator is inclined, the image 42b of the display information 42 appears to be floated by the optical refraction effect at the image transmissive part 26 and the effect that the visual line from the operator substantially becomes parallel to the sidewall 43. That is, as illustrated in FIG. 14(A), when the operator sees the operation key 72, the image 43a of the sidewall 43 on the side far away from the operator becomes lower than the sidewall 43 as a result of the optical refraction effect at the image transmissive part 26. Additionally, when the operator has the optical illusion that the incline image 43a is perpendicular, the operator feels like that the optical illusion of the perpendicular image (43b) becomes smaller. In the case that the image is unconsciously determined to be located beneath the top surface of the operation key 72 like the image 43b in FIG. 14(A), it is recognized that the image of the display information 42 exists at the position of the image 42b in FIG. 14(A). In the case that the operation key 72 is used, the position of the image 42b comes considerably close to the top surface of the operation key 41 as illustrated in FIG. 14(B). Accordingly, the distance from the top surface of the operation key 41 to the image 42b is shortened to considerably improve the feeling that the image 42b of the display information 42 seen through the operation key 72 is retreated.

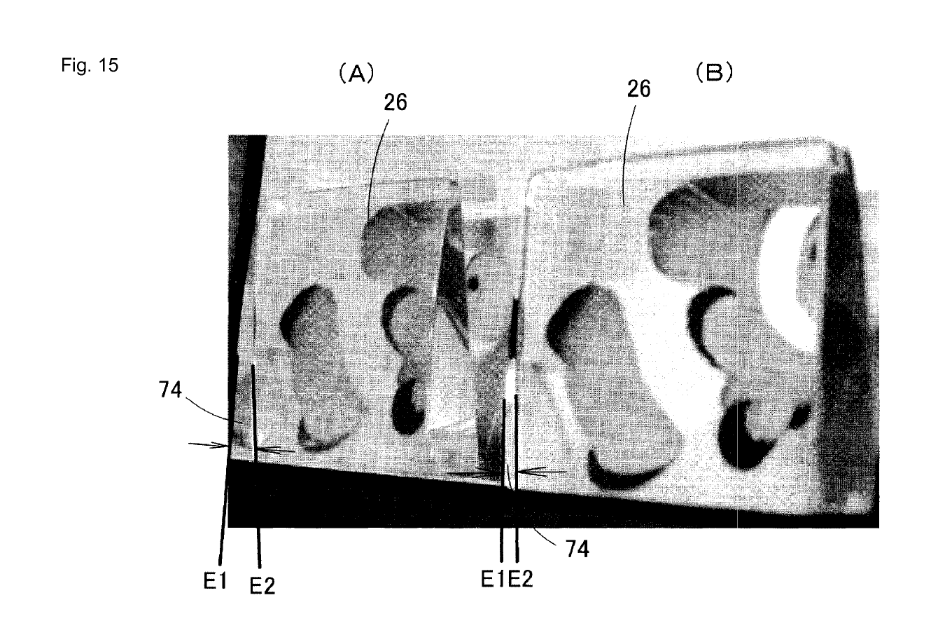

The right or left sidewall 74 is seen in the case that the operator sees the operation key 72 from the position inclined to the right or left. When the sidewall 74 is inclined, the sidewall 74 appears to be small for the same reason as the sidewall 43. As a result, in this case, the operator feels like that the image 42b of the display information 42 exists near the surface of the operation key 72. FIGS. 15(A) and 15(B) illustrate the state in which the sidewall 74 of the side surface is seen. FIG. 15(A) illustrates the case that the sidewall 74 is the perpendicular surface (the sidewall 74 has the inclination angle of 0°), and FIG. 15(B) illustrates the case that the sidewall 74 has the inclination angle of 10°. As can be seen from the comparison of FIGS. 15(A) and 15(B), in the case that the sidewall 74 is inclined, the sidewall 74 appears to be low, and the operator feels like that the image 42a of the display information 42 is floated to the surface of the operation key 72. The symbol E1 indicates the upper end edge of the image of the sidewall 74, and the symbol E2 indicates the lower end edge of the image of the sidewall 74.

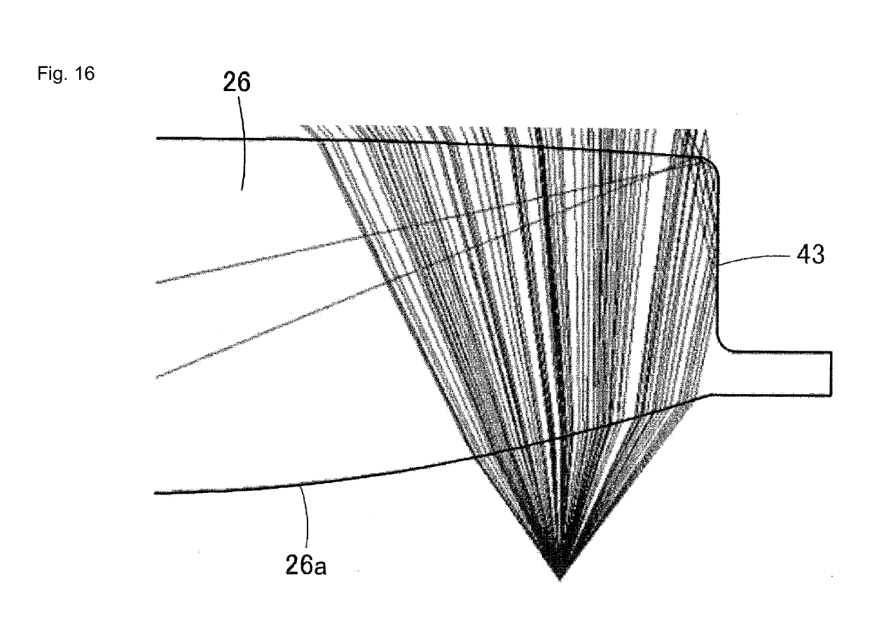

In the case that the sidewall 43 is perpendicular as illustrated in FIG. 16, almost of the light, which exits from the surface of the image display part 22 and enters the image transmissive part 26 in the vicinity of the sidewall 43, is totally reflected by the sidewall 43 and exits immediately in the direction of the operator. Therefore, the image is reflected on the sidewall 43, the position of the sidewall 43 is clearly seen from the operator, and therefore the operator feels like that the display information image displayed on the image display part 22 is retreated from the surface of the image transmissive part 26.

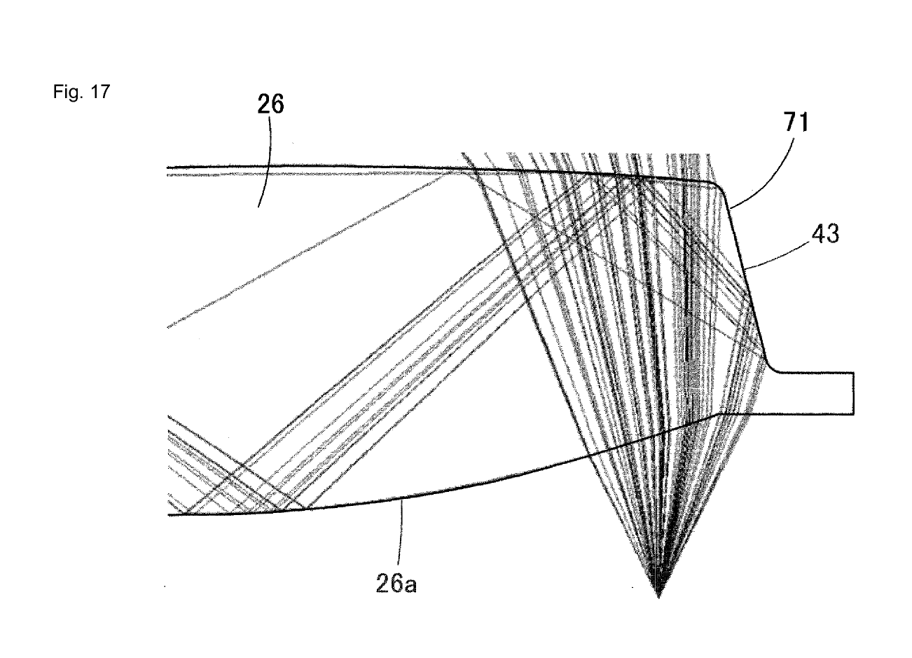

On the other hand, when the sidewall 43 is inclined, as illustrated in FIG. 17, the light, which exits from the surface of the image display part 22 and enters the image transmissive part 26 in the vicinity of the sidewall 43, is reflected by the sidewall 43, and almost of the reflected light is guided while repeatedly totally reflected between the top surface of the image transmissive part 26 and the lower surface. Therefore, an amount of light which exits in the direction of the operator from the image transmissive part 26 immediately after being totally reflected by the sidewall 43 decreases. As a result of hardly reflecting the image on the sidewall 43, the position of the sidewall 43 becomes unclear to the operator, and the operator feels like that the display information image displayed on the image display part 22 exists on the surface of the image transmissive part 26. The advantageous effect is also obtained for the sidewall 74 of the side surface. When the light that is incident to the image transmissive part 26 from the lower surface toward the sidewall 43 has a spread angle of about 39°, desirably the inclination of the sidewall 43 is set to the range of about 15° to about 20° in order that the light reflected by the sidewall 43 hardly exits toward the operator side.

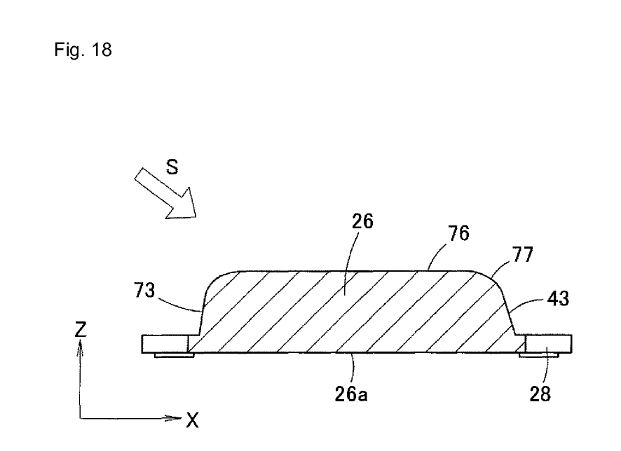

In order to enhance an operation feeling of the operation key, a curved surface 77 having an arc shape in section may be molded at a boundary between the top surface of the image transmissive part 26 and the sidewalls 73, 43, and 74 like an operation key 76 in FIG. 18. However, when the curvature radius of the curved surface 77 is larger than 2.5 mm, because sometimes the sidewall image is doubly reflected at the boundary portion, desirably the curvature radius of the curved surface 77 is set to 2.5 mm or less. Particularly the curvature radius of the curved surface 77 is desirably set to about 0.5 mm.

The position of the display information displayed on the image display part 22 may be adjusted in order to prevent the image from being doubly reflected at the boundary portion between the top surface of the image transmissive part 26 and the sidewalls 73, 43, and 74.

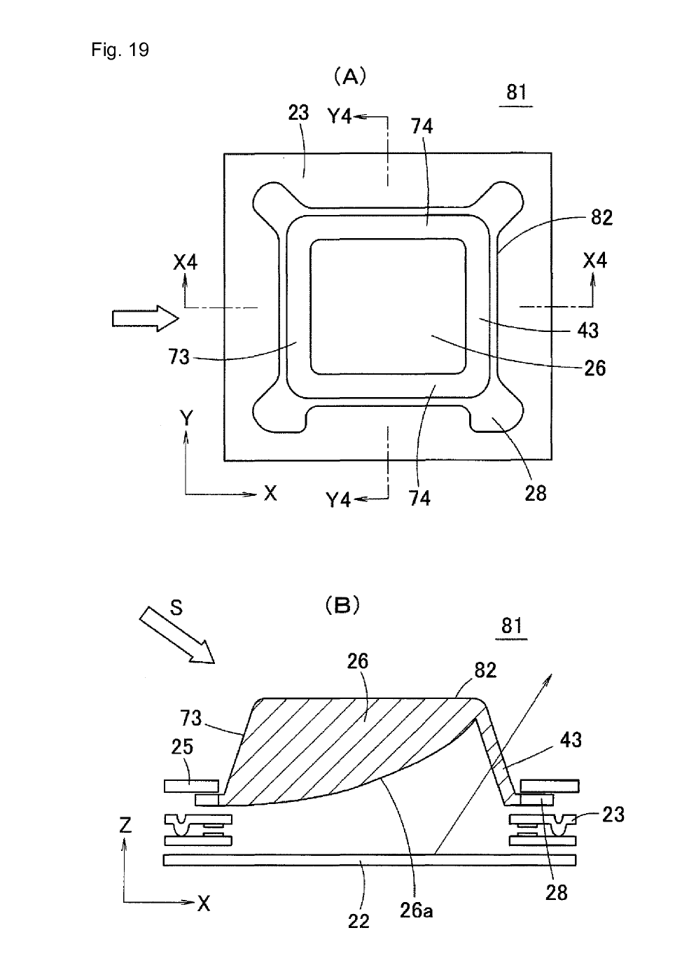

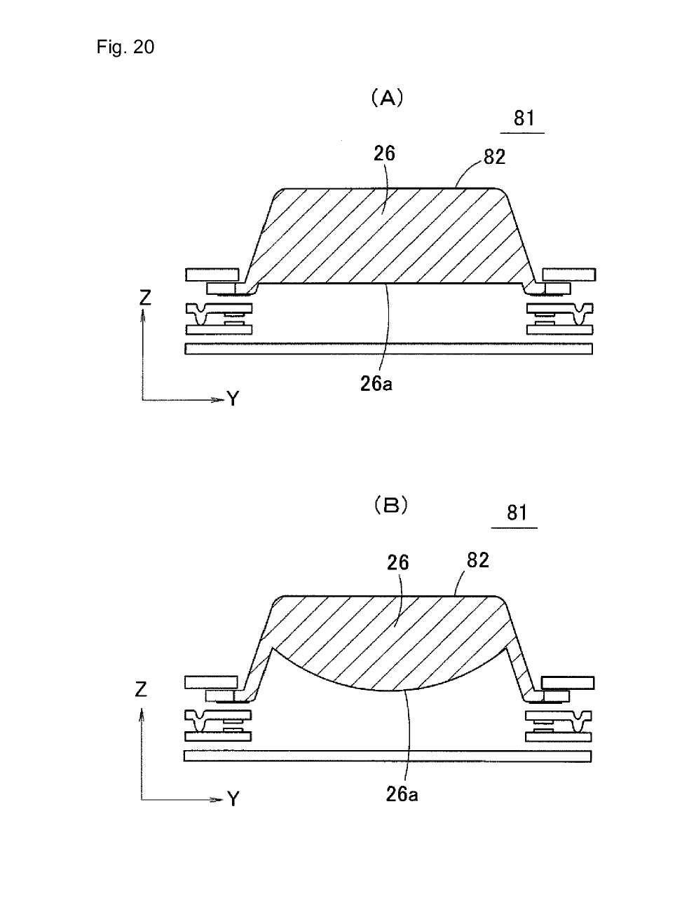

FIG. 19(A) is a plan view (frame 25 is omitted) of a switch unit 81 according to a fourth embodiment of the present invention, and FIG. 19(B) is a sectional view taken on a line X4-X4 of FIG. 19(A). FIGS. 20(A) and 20(B) illustrate a section taken on a line Y4-Y4 in FIG. 19(A).

In the switch unit 81 of the fourth embodiment, the sidewall of the image transmissive part 26 is inclined and the rear surface 26a of the image transmissive part 26 becomes the inclined surface. That is, each outer peripheral surface (sidewall) of the image transmissive part 26 is inclined inward toward the top surface of the image transmissive part 26 from the lower surface. The inclination of the sidewall 73 on the side near the operator is equal to or smaller than the inclinations of the sidewalls 43 and 74. Additionally, the rear surface 26a of the image transmissive part 26 becomes the curved inclined surface, and the rear surface 26a is inclined onto the front surface side of the image transmissive part 26 toward the far side from the side near the operator. The rear surface 26a may be curved into the cylindrical or spherical shape. In the case that the rear surface 26a is curved into the cylindrical shape, the section taken on a line Y4-Y4 of FIG. 19(A) is illustrated in FIG. 20(A). In the case that the rear surface 26a is curved into the spherical shape, the section taken on a line Y4-Y4 of FIG. 19(A) is illustrated in FIG. 20(B).

The switch unit 81 of the fourth embodiment has both the effect that the display information image is floated to the top surface of the image transmissive part 26 by the inclination of the rear surface 26a of the image transmissive part 26 like the first embodiment and the effect that the display information image is floated to the top surface of the image transmissive part 26 by the inclination of the sidewall 43 of the image transmissive part 26 like the third embodiment. Because the light, which exits from the surface of the image display part 22 and is incident to the sidewall 43 on the side far away from the operator, is easily transmitted through the sidewall 43 as indicated by the arrow in FIG. 19(B), the amount of light that is totally reflected by the sidewall 43 to exit in the direction of the operator decreases. As a result of hardly reflecting the image on the sidewall 43, the position of the sidewall 43 becomes unclear to the operator, the operator feels like that the display information image displayed on the image display part 22 exists on the surface of the image transmissive part 26. In the switch unit 81, as a result of overlapping the plural advantageous effects each other, the image 42b of the display information 42 appears to be very near the top surface of the image transmissive part 26, and the exterior of the switch unit 81 becomes fairly good.

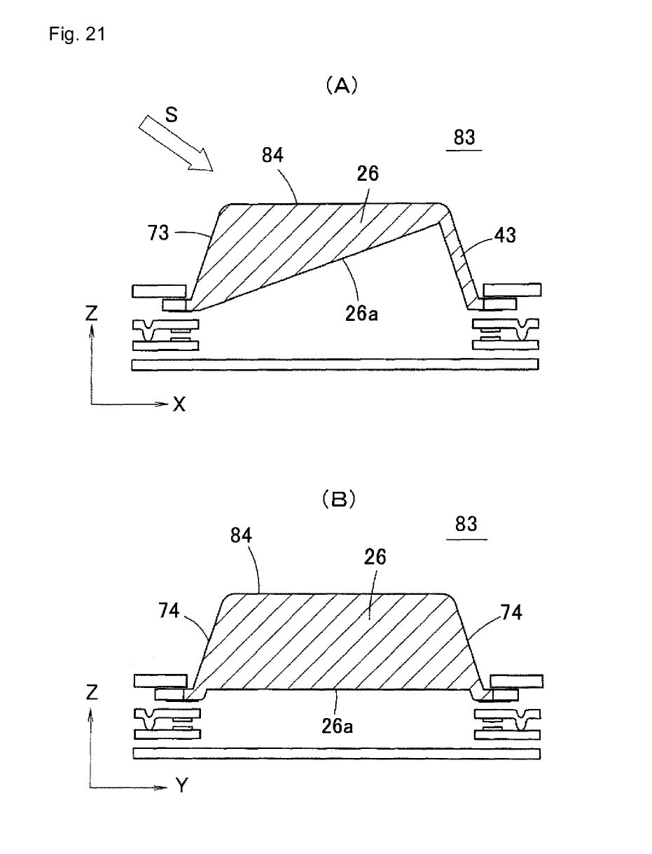

Various modifications can also be made in the fourth embodiment. For example, in operation keys 84 used in a switch unit 83 in FIGS. 21(A) and 21(B), the outer peripheral surface of the image transmissive part 26 is inclined into a trapezoidal shape, and the rear surface 26a of the image transmissive part 26 is formed by the planar inclined surface.

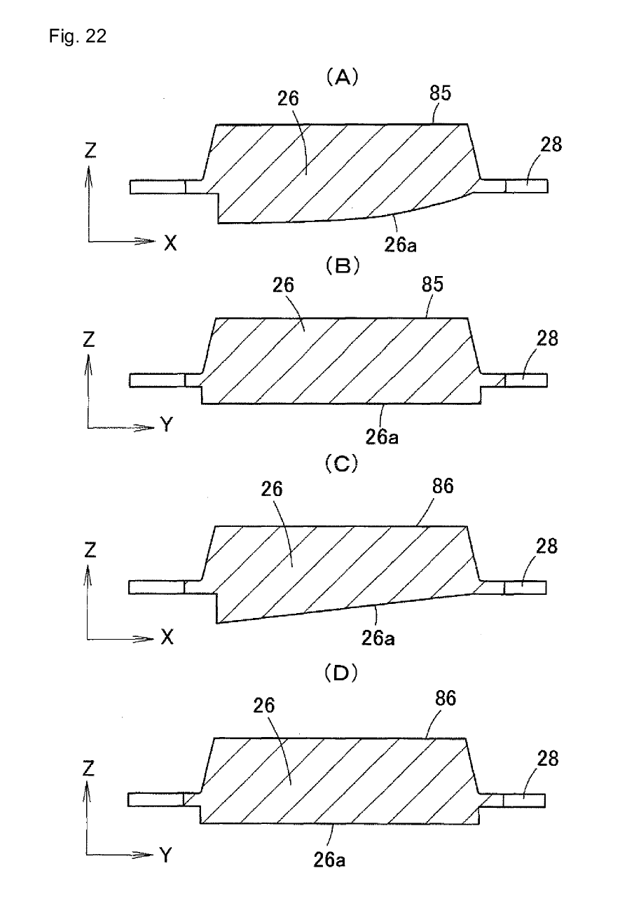

In operation keys 85 in FIGS. 22(A) and 22(B), the outer peripheral surface of the image transmissive part 26 is inclined into the trapezoidal shape, the rear surface 26a of the image transmissive part 26 is formed by the curved inclined surface, and the rear surface 26a projects downward from the lower surface of the leg piece 28. In operation keys 86 in FIGS. 22(C) and 22(D), the outer peripheral surface of the image transmissive part 26 is inclined into the trapezoidal shape, the rear surface 26a of the image transmissive part 26 is formed by the planar inclined surface, and the rear surface 26a projects downward from the lower surface of the leg piece 28. In the case that the rear surface 26a of the image transmissive part 26 projects downward from the lower surface of the leg piece 28, the effect that floats the image to the vicinity of the surface of the image transmissive part 26 is further enhanced compared with the case that the rear surface 26a is retreated upward from the lower surface of the leg piece 28. However, in the case that the rear surface 26a is curved like the operation key 85, there is a risk of slightly deforming the image compared with the case that the planar inclined surface is provided like the operation key 86.

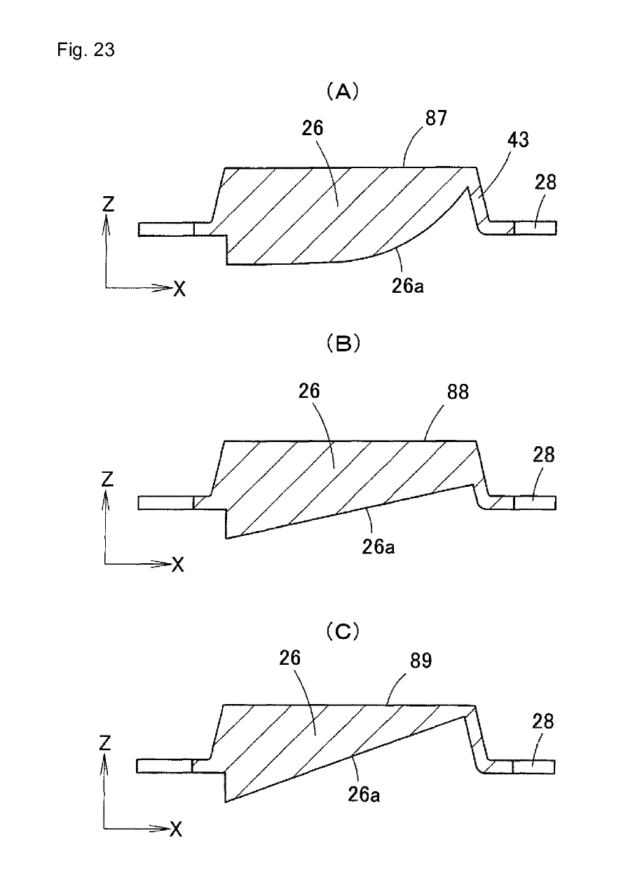

In an operation key 87 in FIG. 23(A), the outer peripheral surface of the image transmissive part 26 is inclined into the trapezoidal shape, the rear surface 26a is formed by the curved inclined surface, the rear surface 26a projects downward from the lower surface of the leg piece 28 on the side near the operator, and the rear surface 26a is deeply retreated to the vicinity of the top surface of the image transmissive part 26 on the side far away from the operator. In the operation key 87, because the inclination of the rear surface 26a becomes sharp in the vicinity of the sidewall 43, the image extends in the X-axis direction. In an operation key 88 in FIG. 23(B), the outer peripheral surface of the image transmissive part 26 is inclined into the trapezoidal shape, the rear surface 26a is formed by the planar inclined surface, the rear surface 26a projects downward from the lower surface of the leg piece 28 on the side near the operator, and the rear surface 26a is retreated upward from the lower surface of the leg piece 28 on the side far away from the operator. In an operation key 89 in FIG. 23(C), the outer peripheral surface of the image transmissive part 26 is inclined into the trapezoidal shape, the rear surface 26a is formed by the planar inclined surface, the rear surface 26a projects downward from the lower surface of the leg piece 28 on the side near the operator, and the rear surface 26a is deeply retreated to the vicinity of the top surface of the image transmissive part 26 on the side far away from the operator.

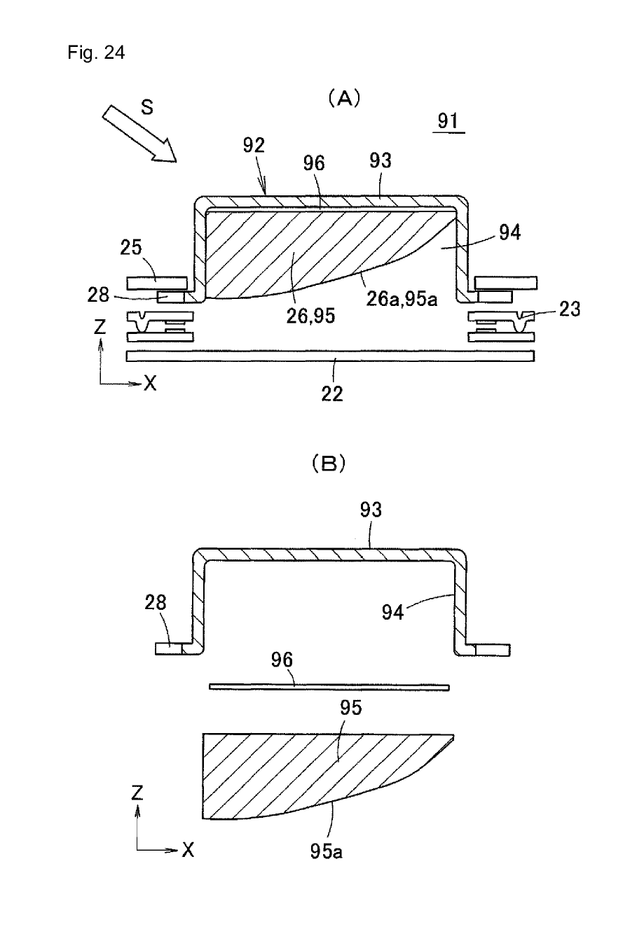

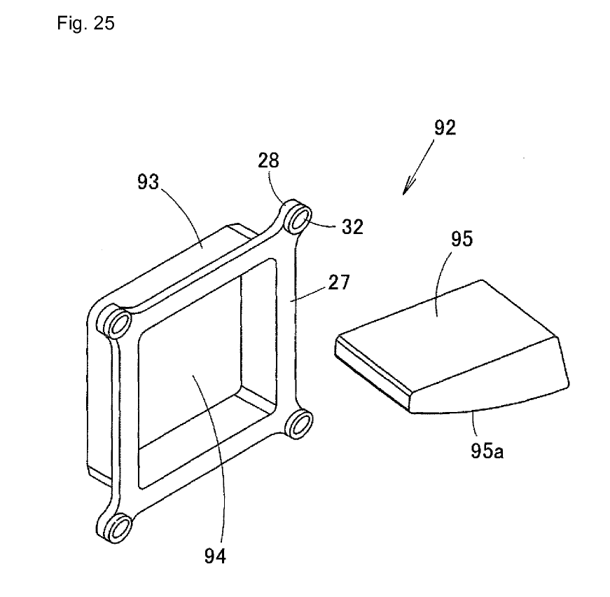

In the above embodiments, the image transmissive part and the operation key are integrally formed. Alternatively, the member constituting the image transmissive part may separately be formed. That is, as illustrated in FIGS. 24(B) and 25, an operation key 92 is divided into a key body 93 and an optical block 95. The key body 93 includes a recess 94 in which the optical block 95 is accommodated, and the flange 27 and the leg piece 28 are provided around the recess 94. In the optical block 95, at least a part of the rear surface 95a includes the inclined surface. In the region where the inclined surface is formed, the optical block 95 is gradually thinned toward one of end portions from the other end portion. As illustrated in a switch unit 91 of FIG. 24(A), the optical block 95 is accommodated in the recess 94 of the key body 93, and bonded to a ceiling surface of the recess 94 using a bonding member 96 such as a transparent bonding agent, a transparent double-sided adhesive tape, and transparent optical oil. In the assembled operation key 92, the image transmissive part 26 is mainly constructed by the optical block 95.

When the operation key 92 is divided into the key body 93 and the optical block 95, the key body or the optical block can be shared between the operation keys having different types.

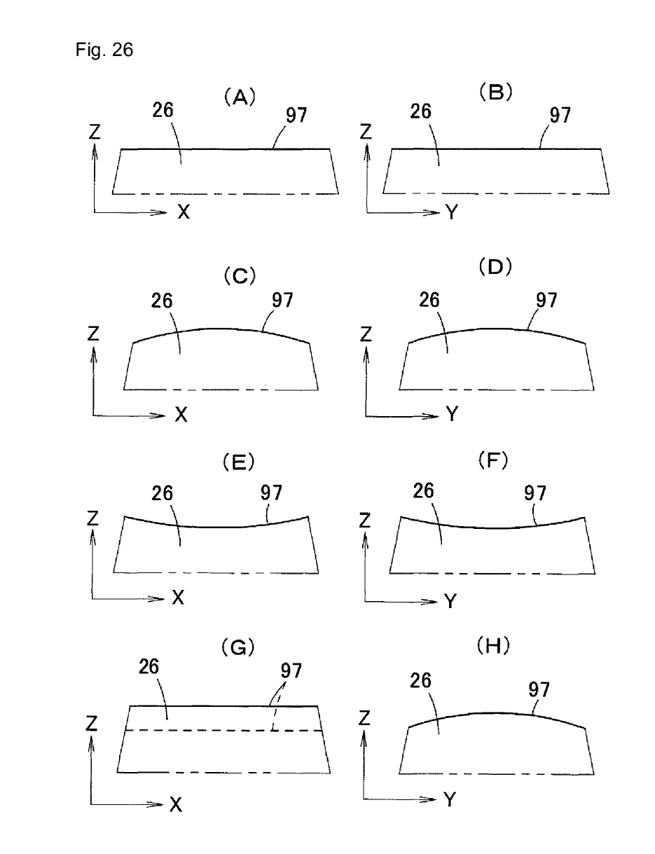

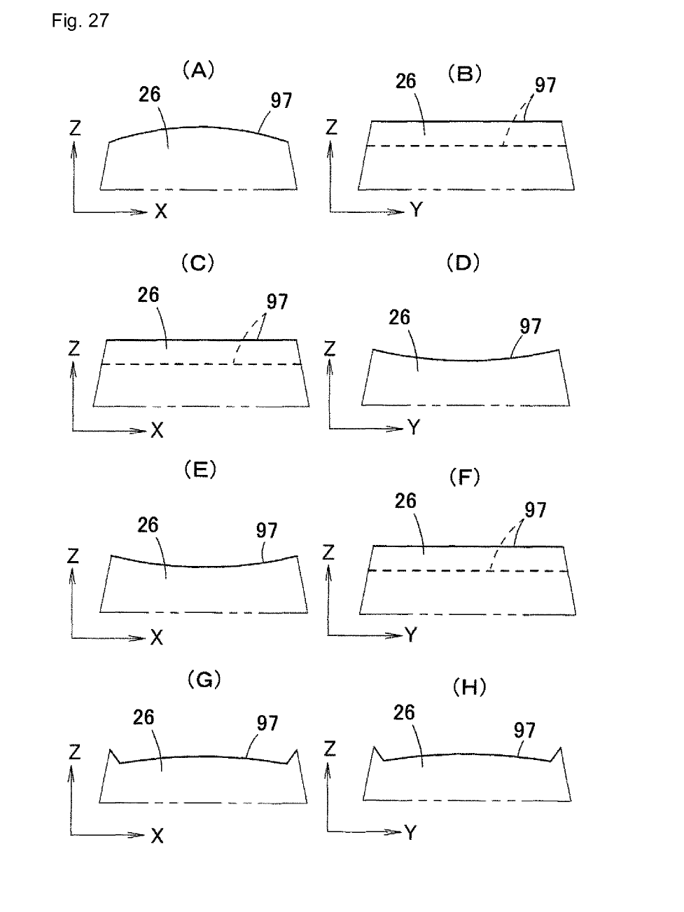

In the above embodiments, a surface 97 (or surface of operation key) of the image transmissive part 26 can be formed into various shapes. FIGS. 26(A) and 26(B) illustrate the case that the surface 97 of the image transmissive part 26 is formed by the planar horizontal surface like the above embodiment. Alternatively, as illustrated in FIGS. 26(C) and 26(D), the surface 97 of the image transmissive part 26 may be formed into the spherical surface swelling upward. FIGS. 26(E) and 26(F) illustrate the case that the surface 97 of the image transmissive part 26 is formed into the spherical surface recessed downward. In FIGS. 26(G) and 26(H), the surface 97 of the image transmissive part 26 is formed into the cylindrical lens shape, in which the surface 97 of the image transmissive part 26 is curved so as to swell upward in the YZ-plane while extending linearly in the X-axis direction. As illustrated in FIGS. 27(A) and 27(B), the surface 97 of the image transmissive part 26 may be formed into the cylindrical lens shape, in which the surface 97 of the image transmissive part 26 is curved so as to swell upward in the ZX-plane while extending linearly in the Y-axis direction. In FIGS. 27(C) and 27(D), the surface 97 of the image transmissive part 26 is formed into the cylindrical lens shape, in which the surface 97 of the image transmissive part 26 is curved so as to be recessed downward in the YZ-plane while extending linearly in the X-axis direction. As illustrated in FIGS. 27(E) and 27(F), the surface 97 of the image transmissive part 26 may be formed into the cylindrical lens shape, in which the surface 97 of the image transmissive part 26 is curved so as to be recessed downward in the ZX-plane while extending linearly in the Y-axis direction. In the image transmissive part 26 in FIGS. 27(G) and 27(H), the surface 97 is formed into the spherical shape in which the inside swells upward, and the outer peripheral portion of the surface 97 is raised.

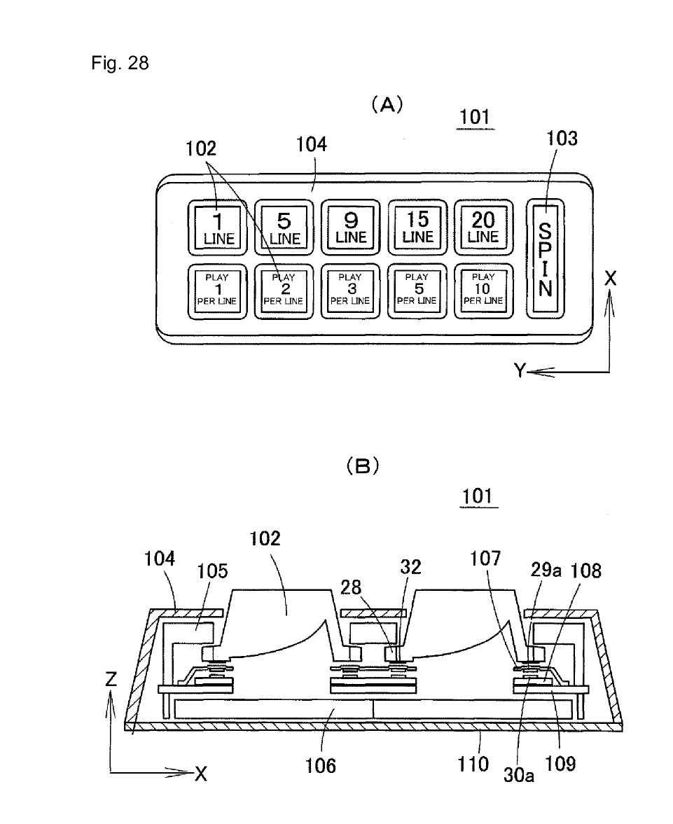

The switch unit of the present invention can be used as switch panels for various game machines, industrial products, and consumer products. For example, a switch unit 101 in FIG. 28(A) is used in a slot machine, and includes an operation key 102 used to input the number of bets and an operation key 103 (spin button) used to rotate and stop a reel.

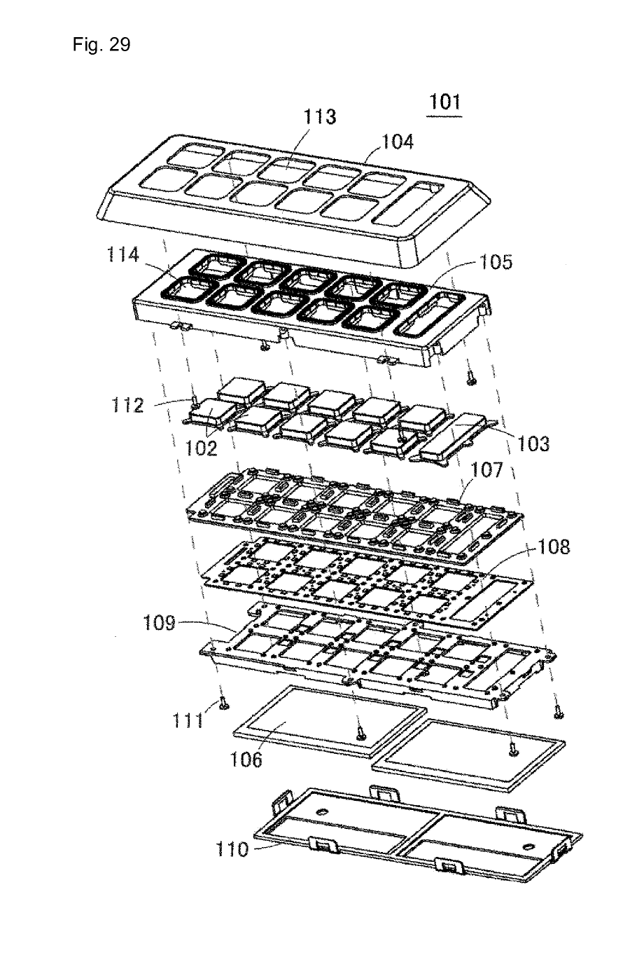

FIG. 29 is an exploded perspective view of the switch unit 101. As illustrated in FIG. 29, the switch unit 101 is constructed from top to bottom by a cover 104, a frame 105, operation keys 102 and 103, a rubber (elastic member) 107 that constitutes the sheet-switch upper board (29), a PCB board 108 that constitutes the sheet-switch lower board (30), a display part case 109 that protects an image display part 106, the image display part 106 such as the liquid crystal display, and a base 110. The cover 104 and the frame 105 include openings 113 and 114 by the numbers of operation keys 102 and 103 according to the positions of the operation keys 102 and 103 such that the operation keys 102 and 103 project upward from the cover 104 and the frame 105.

As illustrated in FIG. 28(B), the PCB board 108, the rubber 107, and the operation keys 102 and 103 are stacked on the display part case 109, the frame 105 is placed on the operation keys 102 and 103, and the frame 105 and the display part case 109 are coupled to each other by screws 111. Then, the cover 104 is stacked on the frame 105, and the cover 104 is fixed to the frame 105 by screws 112. Finally, the image display part 106 is placed on the base 110, and the base 110 is attached to the frame 105 while accommodated below the lower surface of the display part case 109.

The contact 29a is provided on the lower surface of the rubber 107 while opposed to the leg piece of each of the operation keys 102 and 103, and the contact 30a is provided on the upper surface of the PCB board 108 while opposed to the contact 29a. When the operation keys 102 and 103 are pressed, the rubber 107 is elastically deformed to press the contact 29a, and the contact 29a comes into contact with the contact 30a of the PCB board 108.

In the switch unit 101, the plural operation keys 102 and 103 are disposed on the common image display part 106, so that the number of image display parts 106 used can be decreased to reduce the cost of the switch unit 101. The switch unit 101 is thinned, and therefore the switch unit 101 can be downsized.

Although the operation key 103 for spin button has a long rectangular shape, the operation key 103 has the same structure as each operation key of the first to fifth embodiments. That is, the rear surface of the image transmissive part is inclined, or the outer peripheral surface of the operation key is inclined.

As described herein, the invention provides an operation key including an image transmissive part configured to transmit an image of display information located behind the image transmissive part. In the operation key, an inclined surface is formed in at least a part of a rear surface of the image transmissive part, and the inclined surface is inclined onto a front surface side of the image transmissive part toward a far side from a side near an operator. As used herein, the front surface of the image transmissive part means the surface to which the image is projected and in which the image is visually recognized by the operator, and means the surface on the side subjected to a pressing force of the operator during operation. The rear surface of the image transmissive part means the surface opposed to the front surface of the image transmissive part. “The rear surface (inclined surface) of the image transmissive is inclined onto the front surface side” means that the rear surface of the image transmissive comes close to the front surface of the image transmissive part. The operator obliquely sees the image transmissive part. “The inclined surface is inclined toward the far side from the side near the operator” means that the inclined surface is inclined toward the far side from the side near the operator who obliquely sees the image transmissive part in the direction parallel to the front surface of the image transmissive part (the same applies hereinafter).

In the operation key of the first aspect of the present invention, because the rear surface of the image transmissive part is inclined, the image of the sidewall of the image transmissive part (the image reflected on the sidewall) appears to be low from the operator. As a result, the operator feels like the display information image exists near the surface of the image transmissive part, and the operator is given an optical illusion that the display information is recognized near the surface of the operation key.

In the operation key in accordance with the first aspect of the present invention, preferably the inclined surface is a curved surface swelling toward a rear surface side. As used herein, “the inclined surface swells toward the rear surface side” means that the inclined surface swells in the direction separating from the front surface of the image transmissive part (the same applies hereinafter). The inclined surface may be constructed by a spherical surface, or the inclined surface may be constructed by a curved surface having a single arc or complex arc cylindrical shape in section. Accordingly, the operator can feel like the display information image exists nearer to the surface (front surface) of the operation key. The single arc cylindrical shape in section means the curved surface in which a curvature radius along the curved direction is kept constant like an outer peripheral surface of a cylinder. The complex arc cylindrical shape in section means the curved surface (may partially include a planar surface) in which the curvature radius changes divisionally or continuously along the curved direction.

In the operation key in accordance with the first aspect of the present invention, preferably a leg piece configured to push a switch contact extends outward from an outer peripheral surface of the image transmissive part, and at least the part of the rear surface of the image transmissive part projects from a rear surface of the leg piece. Accordingly, the operator can feel like the display information image exists nearer to the surface of the operation key compared with the case that the rear surface of the image transmissive part is retreated onto the surface side from the rear surface of the leg piece.

Preferably the operation key in accordance with the first aspect of the present invention further includes: an operation key body that comprises a recess in a rear surface thereof; and an optical block that comprises the inclined surface in at least a part of a rear surface thereof, the optical block being gradually thinned toward one of ends from the other end in a region where the inclined surface is formed. In the operation key, the optical block is bonded to the recess of the operation key body such that the inclined surface of the rear surface is oriented onto a front surface side of the operation key body toward the far side from the side near the operator. Accordingly, the operation key body and the optical block can be shared among the operation keys having difference part numbers.

In accordance with a second aspect of the present invention, an operation key includes an image transmissive part configured to transmit an image located behind the image transmissive part. In the operation key, at least one of outer peripheral surfaces of the image transmissive part is inclined inward from an end on a rear surface side of the image transmissive part toward an end on a front surface side of the image transmissive part.

In the operation key of the second aspect of the present invention, because the outer peripheral surface of the image transmissive part is inclined, the image of the outer peripheral surface of the image transmissive part (the image reflected on the outer peripheral surface) appears to be low from the operator. As a result, the operator feels like the display information image exists near the surface (front surface) of the image transmissive part, and the operator is given the optical illusion that the display information is recognized near the surface of the operation key.

In the operation key in accordance with the second aspect of the present invention, preferably at least outer peripheral surfaces, which constitute both side surfaces in the outer peripheral surfaces of the image transmissive part when viewed from an operator, are inclined inward from the end on the rear surface side of the image transmissive part toward the end on the front surface side of the image transmissive part. Accordingly, in the case that the operation key is laterally seen, the outer peripheral surface of the side surface appears to be low, and the operator feels like the display information exists near the surface of the operation key due to the optical illusion.

In the operation key in accordance with the second aspect of the present invention, preferably, in outer peripheral surfaces of the image transmissive part, at least the outer peripheral surface located on a side near an operator and the outer peripheral surface located on a side far away from the operator are inclined inward from the end on the rear surface side of the image transmissive part toward the end on the front surface side of the image transmissive part, and, assuming that P is an inclination angle of which the inclined surface located on the side near the operator is measured in a direction perpendicular to the image transmissive part, and that Q is an inclination angle of which the inclined surface located on the side far away from the operator is measured in the direction perpendicular to the image transmissive part, P≦Q is satisfied. Accordingly, the outer peripheral surface located on the side far away from the operator appears to be low. On the other hand, because the outer peripheral surface located on the side near the operator has a relatively small inclination, light exiting from the display information hardly enters eyes of the operator through the outer peripheral surface located on the side near the operator. As a result, the operator feels like the display information exists near the surface of the operation key due to the optical illusion.

In the operation key in accordance with the second aspect of the present invention, preferably an inclined surface is formed in at least a part of a rear surface of the image transmissive part, and the inclined surface is inclined onto a front surface side of the image transmissive part toward a far side from a side near an operator. The inclined surface may be a curved surface swelling toward the rear surface side. Accordingly, the display information image can be brought closer to the surface of the operation key by a synergistic effect between the inclined outer peripheral surface of the image transmissive part and the inclined rear surface of the image transmissive part.

Preferably the operation key in accordance with the second aspect of the present invention further includes: an operation key body that comprises a recess in a rear surface thereof; and an optical block that comprises the inclined surface in at least a part of a rear surface thereof, the optical block being gradually thinned toward one of ends from the other end in a region where the inclined surface is formed. In the operation key, the optical block is bonded to the recess of the operation key body such that the inclined surface of the rear surface is oriented onto a front surface side of the operation key body toward the far side from the side near the operator. Accordingly, the operation key body and the optical block can be shared among the operation keys having difference part numbers.

In accordance with a third aspect of the present invention, a switch unit includes: the one or plural first or second operation keys of the present invention; an image display part that is disposed behind the operation key; and a switch body configured to be switched by an operation of the operation key. In the switch unit of the third aspect of the present invention, the display information is displayed on the image display part behind the operation key, and the display information image is reflected on the surface of each operation key, so that the switch unit having the good appearance and usability can be prepared.

The means for solving the problem of the present invention has the feature in which the above constituents are properly combined, and various variations can be made by the combination of the constituents.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. An operation key comprising:
an image transmissive part configured to transmit an image of display information located behind the image transmissive part,
wherein an inclined surface is formed in at least a part of a rear surface of the image transmissive part, and
the inclined surface is inclined onto a front surface side of the image transmissive part toward a far side from a side near an operator.

2. The operation key according to claim 1, wherein the inclined surface is a curved surface swelling toward a rear surface side.

3. The operation key according to claim 2, wherein the inclined surface comprises a spherical surface.

4. The operation key according to claim 2, wherein the inclined surface comprises a curved surface having a single arc or a complex arc cylindrical shape in section.

5. The operation key according to claim 1, wherein a leg piece configured to push a switch contact extends outward from an outer peripheral surface of the image transmissive part, and at least a part of the rear surface of the image transmissive part projects from a rear surface of the leg piece.

6. The operation key according to claim 1, further comprising:
an operation key body that comprises a recess in a rear surface thereof; and
wherein the image transmissive part comprises an optical block that comprises the inclined surface in at least a part of a rear surface thereof, the optical block being gradually thinned toward one of ends from the other end in a region where the inclined surface is formed,
wherein the optical block is bonded to the recess of the operation key body.

7. An operation key comprising:
an image transmissive part configured to transmit an image located behind the image transmissive part,
wherein at least one of outer peripheral surfaces of the image transmissive part is inclined inward from an end on a rear surface side of the image transmissive part toward an end on a front surface side of the image transmissive part.

8. The operation key according to claim 7, wherein at least outer peripheral surfaces, which constitute both side surfaces in the outer peripheral surfaces of the image transmissive part when viewed from an operator, are inclined inward from the end on the rear surface side of the image transmissive part toward the end on the front surface side of the image transmissive part.

9. The operation key according to claim 7, wherein at least the outer peripheral surface located on a side near an operator and the outer peripheral surface located on a side far away from the operator are inclined inward from the end on the rear surface side of the image transmissive part toward the end on the front surface side of the image transmissive part, and
assuming that P is an inclination angle of which the inclined surface located on the side near the operator is measured in a direction perpendicular to the image transmissive part, and that Q is an inclination angle of which the inclined surface located on the side far away from the operator is measured in the direction perpendicular to the image transmissive part, P≦Q is satisfied.

10. The operation key according to claim 7, wherein an inclined surface is formed in at least a part of a rear surface of the image transmissive part, and
the inclined surface is inclined onto a front surface side of the image transmissive part toward a far side from a side near an operator.

11. The operation key according to claim 10, wherein the inclined surface is a curved surface swelling toward the rear surface side.

12. The operation key according to claim 7, further comprising:
an operation key body that comprises a recess in a rear surface thereof; and
wherein the image transmissive part comprises an optical block that comprises the inclined surface in at least a part of a rear surface thereof, the optical block being gradually thinned toward one of ends from the other end in a region where the inclined surface is formed, and
wherein the optical block is bonded to the recess of the operation key body such that the inclined surface of the rear surface is oriented onto a front surface side of the operation key body toward the far side from the side near the operator.

13. A switch unit comprising:
one or more of the operation key according to claim 1;
an image display part that is disposed behind the operation key; and
a switch body configured to be switched by an operation of the operation key.
